(19) United States
(12) Patent Application Publication
(10) Pub. No.: US 2026/0085795 A1
(43) Pub. Date: Mar. 26, 2026

(54) SYSTEMS AND METHODS FOR RECOVERY OF HYDROCARBON LIQUIDS IN OIL AND GAS PIPELINES

(71) Applicant: ZENRG Services, LLC, Houston, TX (US)

(72) Inventors: Sam EDWARDS, Sugar Land, TX (US); Joe CHANDLER, Houston, TX (US); Cameron BRASIER, Spring, TX (US); Ronald WILLIAMS, Kingwood, TX (US)

(21) Appl. No.: 19/335,430

(22) Filed: Sep. 22, 2025

Related U.S. Application Data
(60) Provisional application No. 63/696,919, filed on Sep. 20, 2024.

(51) Int. Cl. F17D 3/10; F17D 3/12; F17D 1/00

(52) U.S. Cl. CPC F17D 3/10; F17D 3/12; F17D 1/005

(57) ABSTRACT

Systems and methods for recovering hydrocarbon liquids from oil and gas pipelines are provided that include a tap provided in a section of pipe within a pipeline, wherein the tap includes a straw arranged to extend within the section of the pipe to a low point of the section of pipe; and a pump or compressor arranged to be fluidically coupled to the tap via a first conduit, wherein the pump or compressor is arranged to: draw liquid from the low point of the section of pipe via the tap and the conduit until a pressure within the section of pipe drops to a predetermined pressure; cross-compress the liquid, to raise the pressure from a first pressure to a second pressure that is higher than the first pressure; and inject the liquid at the second pressure back into the pipeline at a location downstream of the tap or into another adjoining pipeline or into a customer asset or into a storage container via a second conduit.

### CROSS-REFERENCE TO RELATED APPLICATIONS

This application claims priority under 35 U.S.C. § 119(e) to U.S. Provisional Application No. 63/696,919 filed September 20, 2024, the entire contents of which are hereby expressly incorporated by reference herein.

### FIELD

The subject matter described herein relates to systems and methods for recovering hydrocarbon liquids from oil and gas pipelines, particularly during purging and pressure equalizing operations.

### BACKGROUND

Production oil and gas wells can accumulate liquids or condensate in the low points of pipe sections of a well. This liquid accumulation/condensation can cause issues downstream of the pipeline and can require evacuation to ensure the pipeline’s safety, longevity, and efficiency.

For example, accumulated liquids or condensates can be problematic in pipelines, as they can obstruct the flow of gas or oil, which can increase the frictional resistance and/or pressure drop in the pipeline, reduce pipeline efficiency and potentially cause blockages. Additionally, accumulated liquids or condensates can be problematic, as they can lead internal corrosion or the formation of hydrates within the pipeline. Pipelines can be subject to regulatory requirements that require operators to routinely remove these accumulated liquids to mitigate the risks described above.

Conventionally, wells that experience this sort of liquid or condensate accumulation are evacuated, and the liquids and condensate are flared off to the atmosphere. This conventional method can have detrimental environmental and safety implications and result in significant financial loss of the valuable liquids and condensates that are flared. Additionally, while majority of liquids can be extracted using conventional methods of pulling the liquids off of the top of the pipeline, these methods can leave liquid remnants in low points in the pipeline, which require longer times to extract, as an operator has to continue to pull and wait for the remaining liquids to vapor off once the pipeline gets below the vapor pressure of the liquids.

### SUMMARY

In one aspect of the present disclosure, a method is provided. The method comprises coupling a conduit at a first end to a tap provided in a section of pipe within a pipeline, wherein the tap comprises a straw configured to extend within the section of the pipe to a low point of the section of pipe. The method comprises drawing liquid from the low point of the section of pipe via the conduit using a pump or compressor coupled to a second end of the conduit, wherein the pump or compressor is configured to draw liquid from the low point of the section of pipe until a pressure within the section of pipe drops to a predetermined pressure. The method comprises cross-compressing the liquid, by the pump or compressor, to raise the pressure from a first pressure to a second pressure that is higher than the first pressure. The method comprises injecting the liquid at the second pressure back into the pipeline at a location downstream of the tap or into another adjoining pipeline, or into a customer asset or into a storage container via a second conduit.

In some aspects, the method may include one or more of the following features.

In some aspects, the pipeline may be a liquid pipeline.

In some aspects, the pipeline may be a natural gas pipeline, and the liquid may be injected into the storage container.

In some aspects, the storage container may be a pressurized vessel.

In some aspects, the storage container may be a vac-truck.

In some aspects, the second conduit may be coupled at a first end to an outlet of the pump or compressor and at a second end to a second tap provided downstream of the tap.

In some aspects, the method may further comprise disconnecting the conduit from the tap after injecting the liquid back into the pipeline.

In some aspects, the method may further comprise filtering the liquid through a filter vessel prior to cross-compressing the liquid.

According to another aspect of the present disclosure, a system is provided. The system comprises a tap provided in a section of pipe within a pipeline, wherein the tap comprises a straw configured to extend within the section of the pipe to a low point of the section of pipe. The system comprises a pump or compressor configured to be fluidically coupled to the tap via a first conduit, wherein the pump or compressor is configured to draw liquid from the low point of the section of pipe via the tap and the conduit until a pressure within the section of pipe drops to a predetermined pressure, cross-compress the liquid, to raise the pressure from a first pressure to a second pressure that is higher than the first pressure, and inject the liquid at the second pressure back into the pipeline at a location downstream of the tap or into another adjoining pipeline or into a customer asset or into a storage container via a second conduit.

In some aspects, the system may include one or more of the following features.

In some aspects, the pipeline may be a liquid pipeline.

In some aspects, the pipeline may be a natural gas pipeline, and the pump or compressor may be configured to inject the liquid into the storage container via the second conduit.

In some aspects, the storage container may be a pressurized vessel.

In some aspects, the storage container may be a vac-truck.

In some aspects, the second conduit may be coupled at a first end to an outlet of the pump or compressor and at a second end to a second tap provided downstream of the tap.

In some aspects, the pump or compressor and the first conduit may be configured to be fluidically de-coupled from the tap after the liquid is injected back into the pipeline.

In some aspects, the system may further comprise a filter vessel provided between the tap and the pump or compressor, wherein the filter vessel is configured to receive the liquid from the tap, filter the liquid to remove particulates and send the filtered liquid to the pump or compressor for cross-compression.

According to another aspect of the present disclosure, a system is provided. The system comprises a tap assembly configured to be welded to a drawdown section of a pipeline, wherein the tap comprises a drip-tube straw configured to extend within the section of the pipeline to a low point of the section of pipeline where hydrocarbon liquids accumulate. The system comprises a pump or compressor fluidically connected to the tap via a first conduit, wherein the pump or compressor is configured to extract hydrocarbon liquids from the low point of the section of pipe via the tap assembly and the first conduit until a pressure within the section of pipe is reduced to a predetermined pressure that is close to atmospheric pressure, cross-compress the hydrocarbon liquids from an initial pressure to an elevated pressure that is higher than the initial pressure, and discharge the pressurized hydrocarbon liquids back into the pipeline at a location downstream of the tap assembly or into another adjoining pipeline or into a customer asset or into a storage container via a second conduit, wherein the system is configured to operate while the pipeline remains in full operation.

In some aspects, the system may include one or more of the following features.

In some aspects, the storage container may be a pressurized vessel or a vac-truck.

In some aspects, the second conduit may be coupled at a first end to an outlet of the pump or compressor and at a second end to a second tap assembly provided downstream of the tap assembly.

In some aspects, the system may further comprise a filtration unit positioned between the tap assembly and the pump or compressor, wherein the filtration unit is configured to receive the hydrocarbon liquids from the tap assembly, filter the hydrocarbon liquids to remove paraffin, solids, and other pipeline contaminants that can block or limit efficiency of the pump or compressor, and send the filtered hydrocarbon liquids to the pump or compressor for cross-compression.

### BRIEF DESCRIPTION OF THE DRAWINGS

FIGS. 1A-1B are system diagrams illustrating exemplary systems for recovering hydrocarbon liquids from pipelines, according to aspects of the present disclosure; and

FIG. 2 illustrates a cross-sectional view of a drawdown section of a pipeline with a tap assembly, according to aspects of the present disclosure.

### DETAILED DESCRIPTION

The systems and methods described herein are advantageously capable of evacuating liquids that accumulate in the bottoms of sections of pipe within a pipeline, while the pipeline is still in full operation. The evacuated liquids are then recovered and reinjected back into the pipeline system or into a pressurized temporary storage vessel, rather than flaring the liquids to the atmosphere. For example, in a natural gas pipeline that is experiencing condensate build-up, the systems and methods described herein can be used to evacuate the condensate from the pipeline (e.g., from low points within the pipe), for the health of the pipeline and downstream facilities. In liquids pipelines, as another example, the systems and methods described herein can be used to evacuate liquids from the pipeline (e.g., from low points within the pipe), for further work (e.g., processing, blending, filtering, sampling, quality control, etc.) or to address a customer need (e.g., maintenance, repair, etc.). In situations like the example provided above, the liquids in the pipeline can be extremely valuable in a monetary sense. For example, a pipeline containing highly reactive volatile organic compounds (HRVOC’s) can cost around $700 per metric ton. Accordingly, the systems and methods described herein provide an effective and efficient way to recover these valuable liquids, rather than flaring them to the environment, thereby reducing or eliminating the environmental impact of these evacuation processes while shielding the users thereof from product losses which are directly correlated to financial losses.

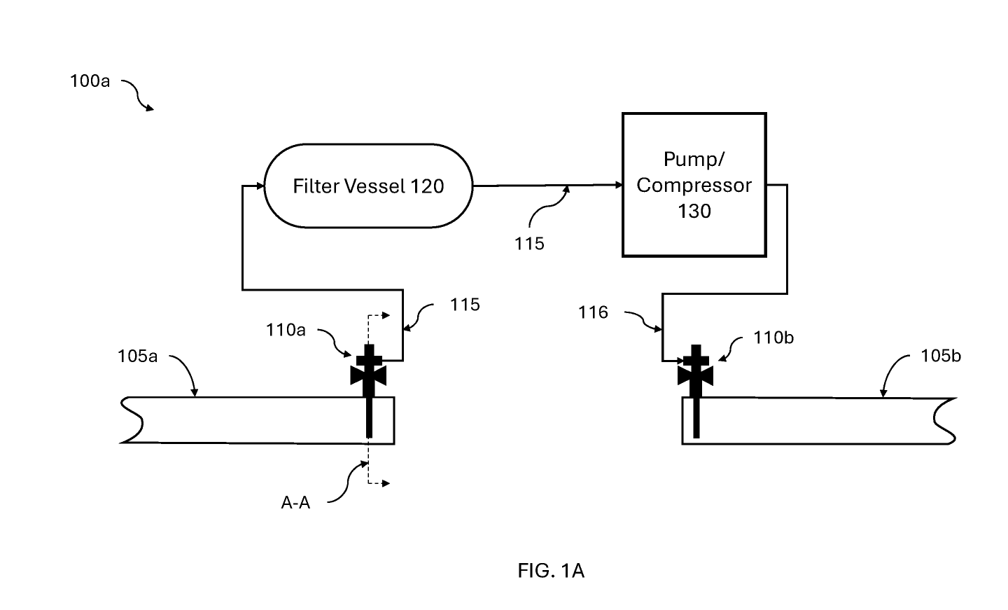

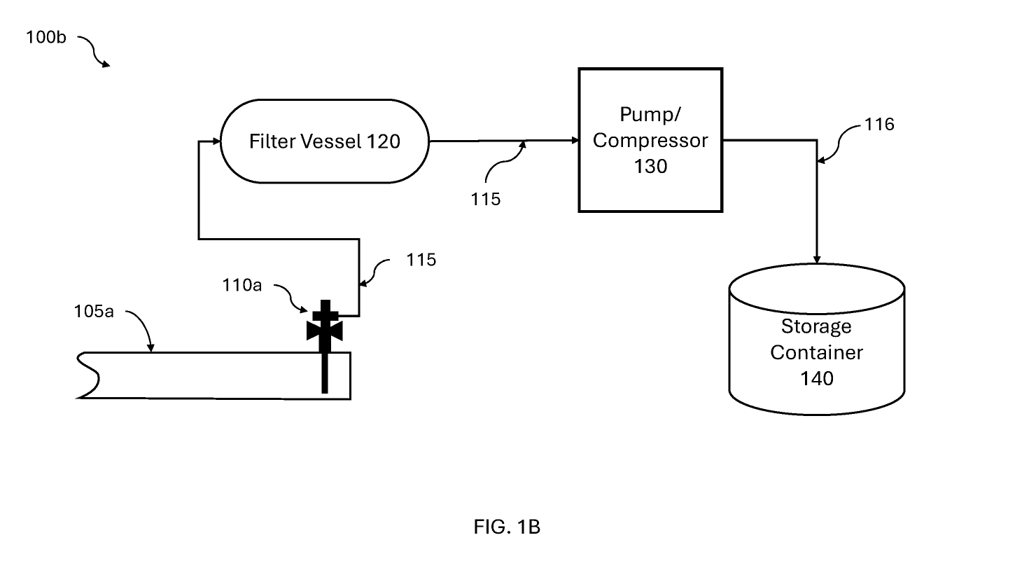

FIGS. 1A-1B are system diagrams illustrating two exemplary systems 100a, 100b, respectively, that can be used for evacuating liquids that accumulate in the bottoms of sections of pipe within a pipeline, recovering the evacuated liquids and reinjecting them back into the pipeline system or into a temporary storage vessel, rather than flaring the liquids to the atmosphere. Accordingly, the systems 100a, 100b substantially reduce pollutant emissions and substantially increase product recovery in oil and gas operations.

As shown in FIGS. 1A-1B the systems 100a and 100b can each include a first tap 110a, a filter vessel 120, a pump or compressor 130. In some aspects, the first tap 110a can be configured to tap into a drawdown section 105a of a pipeline. The first tap 110a can be a hot tap that is welded to the drawdown section and can include various components, as described in greater detail below. In some aspects, for example, the first tap 110a can be a THREAD-O-RING™ (TOR) Fitting, manufactured by T.D. Williamson, or the like. In some aspects the filtration system (filter vessel 120) and the pump or compressor 130 can be fluidically coupled to the first tap 110a, via a conduit 115, to pull fluids from the drawdown section 105a of the pipeline, during for example a re-compression operation of the like, as discussed below.

System 100a, as shown in FIG. 1A can be used, for example, to re-inject fluids back into a discharge section 105b of the pipeline, via a second conduit 116 and a second tap 110b, as described in greater detail below. Alternatively, system 100b, as shown in FIG. 1B can be used, for example, to temporarily store the evacuated fluids in a tote, tank or other temporary pressurized vessel (e.g., storage container 140), via the second conduit 116, as described in greater detail below.

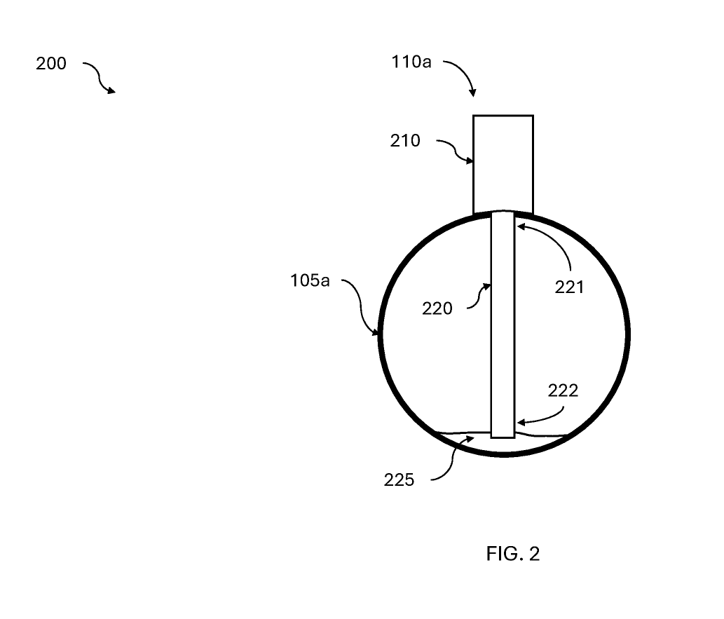

FIG. 2 illustrates an exemplary cross-sectional view 200, taken along section A-A of FIG. 1A, of the drawdown section 105a of the pipeline, including the first tap 110a. As shown in FIG. 2, the first tap 110a can include at least a plug/cap assembly 210 and a drip tube 220. The plug/cap assembly 210 can be welded to the surface of the drawdown section 105a of the pipeline and can be tapped out (e.g., during a hot-tapping operation) to produce a hole through which the drip tube 220 can be inserted. As shown in FIG. 2, the drip tube 220 can be configured to extend from a proximal end 221, located in an upper region of the section 105a of pipe, to a distal end 222, positioned in a low point of pipe section 105a, which can accumulate liquids 225.

With reference to FIGS. 1A and 2, during a re-injection operation, as shown in FIG. 1A, an operator can couple the conduit 115 of the system 100a, to the plug/cap assembly 210 of the first tap 110a provided in the section 105a of a pipeline. Once the conduit 115 is coupled to the first tap, the pump/compressor 130 can be powered to draw liquid 225 from the low point of the section 105a of pipe via the drip tube 220 and the conduit 115. In some aspects, the system 110a can be arranged to draw liquid from the drawdown section 105a until a pressure within the section of pipe drops to a predetermined pressure (e.g., close to atmospheric). In some aspects, the filter vessel 120 can be provided between the tap 110a and the pump/compressor 130 to filter the liquid 225 from the low point of the section 105a. For example, in some cases, the low points of pipelines can contain paraffin and other solids which, when picked up by the liquids being drawn by the system, can block or limit the efficiency of the pump/compressor. Accordingly the filter vessel 120 can be arranged to remove paraffin, other solids, and any other commonly known pipeline contaminants, from the liquids that are drawn from the drawdown section 105a. Once the liquid 225 is filtered, it can be pulled into an inlet section of the pump/compressor 130 and cross-compressed, to raise the pressure of the liquid from a first pressure to a second pressure that is higher than the first pressure. Once the liquid is cross-compressed, it can be sent out of an outlet section of the pump/compressor 130 and can be injected into the discharge pipeline section 105b, via the second conduit 116 and the second tap 110b. In some aspects, the second tap 110b and be similar to the first tap 110a.

With reference to FIGS. 1B and 2, during a temporary storage operation, as shown in FIG. 1B, an operator can couple the conduit 115 of the system 100b, to the plug/cap assembly 210 of the first tap 110a. Once coupled, the operator can perform the same operations described above, of drawing liquid 225 from the low point of the pipe 105a until a pressure within the section of pipe drops to a predetermined pressure, filtering the liquid 225 in the filter vessel 120 and cross-compressing the liquid in the pump/compressor 130. However, during a temporary storage operation, as shown in FIG. 1B, the operator can couple the conduit 116 to a storage container 140. In some aspects, the storage container 140 can be a pressurized temporary storage vessel/tank (e.g., a vac-truck or a tote or the like).

For example, in cases where the pipeline is a liquid pipeline containing valuable liquids (e.g., HRVOC’s, as described above), it is desirable to recover as much of the evacuated product as possible. Accordingly, in some aspects, the systems and methods described herein can be used in the either the re-injection or the temporary storage operations, described above. In the re-injection operation, the liquids can be extracted and filtered, as described above, and then either pumped back into the pipeline, downstream of the valve extraction, or pump the liquids into an adjacent pipeline at/near the extraction location. In the temporary storage operation, the liquids can be extracted and filtered, as described above, and then pumped into a temporary storage container (e.g., a vac-truck or the like) and transported to a remote site for use.

In another example, where the pipeline is a natural gas pipeline belonging to a company, the company may not want to keep the condensate or other liquids, for whatever reason. Accordingly, in some aspects, the systems and methods described herein can be used in the temporary storage operation capacity, described above, and taken away from the company site in a vac-truck or the like.

1. A method comprising:
coupling a conduit at a first end to a tap provided in a section of pipe within a pipeline, wherein the tap comprises a straw configured to extend within the section of the pipe to a low point of the section of pipe;
drawing liquid from the low point of the section of pipe via the conduit using a pump or compressor coupled to a second end of the conduit, wherein the pump or compressor is configured to draw liquid from the low point of the section of pipe until a pressure within the section of pipe drops to a predetermined pressure;
cross-compressing the liquid, by the pump or compressor, to raise the pressure from a first pressure to a second pressure that is higher than the first pressure; and
injecting the liquid at the second pressure back into the pipeline at a location downstream of the tap or into another adjoining pipeline, or into a customer asset or into a storage container via a second conduit.

2. The method of claim 1, wherein the pipeline is a liquid pipeline.

3. The method of claim 1, wherein the pipeline is a natural gas pipeline, and the liquid is injected into the storage container.

4. The method of claim 1, wherein the storage container is a pressurized vessel.

5. The method of claim 1, wherein the storage container is a vac-truck.

6. The method of claim 1, wherein the second conduit is coupled at a first end to an outlet of the pump or compressor and at a second end to a second tap provided downstream of the tap.

7. The method of claim 1, further comprising:
disconnecting the conduit from the tap after injecting the liquid back into the pipeline.

8. The method of claim 1, further comprising:
filtering the liquid through a filter vessel prior to cross-compressing the liquid.

9. A system comprising:
a tap provided in a section of pipe within a pipeline, wherein the tap comprises a straw configured to extend within the section of the pipe to a low point of the section of pipe; and
a pump or compressor configured to be fluidically coupled to the tap via a first conduit, wherein the pump or compressor is configured to:
draw liquid from the low point of the section of pipe via the tap and the conduit until a pressure within the section of pipe drops to a predetermined pressure;
cross-compress the liquid, to raise the pressure from a first pressure to a second pressure that is higher than the first pressure; and
inject the liquid at the second pressure back into the pipeline at a location downstream of the tap or into another adjoining pipeline or into a customer asset or into a storage container via a second conduit.

10. The system of claim 9, wherein the pipeline is a liquid pipeline.

11. The system of claim 9, wherein the pipeline is a natural gas pipeline, and the pump or compressor is configured to inject the liquid into the storage container via the second conduit.

12. The system of claim 9, wherein the storage container is a pressurized vessel.

13. The system of claim 9, wherein the storage container is a vac-truck.

14. The system of claim 9, wherein the second conduit is coupled at a first end to an outlet of the pump or compressor and at a second end to a second tap provided downstream of the tap.

15. The system of claim 9, wherein the pump or compressor and the first conduit are configured to be fluidically de-coupled from the tap after the liquid is injected back into the pipeline.

16. The system of claim 9, further comprising:
a filter vessel provided between the tap and the pump or compressor, wherein the filter vessel is configured to receive the liquid from the tap, filter the liquid to remove particulates and send the filtered liquid to the pump or compressor for cross-compression.

17. A system comprising:
a tap assembly configured to be welded to a drawdown section of a pipeline, wherein the tap comprises a drip-tube straw configured to extend within the section of the pipeline to a low point of the section of pipeline where hydrocarbon liquids accumulate; and
a pump or compressor fluidically connected to the tap via a first conduit, wherein the pump or compressor is configured to:
extract hydrocarbon liquids from the low point of the section of pipe via the tap assembly and the first conduit until a pressure within the section of pipe is reduced to a predetermined pressure that is close to atmospheric pressure;
cross-compress the hydrocarbon liquids from an initial pressure to an elevated pressure that is higher than the initial pressure; and
discharge the pressurized hydrocarbon liquids back into the pipeline at a location downstream of the tap assembly or into another adjoining pipeline or into a customer asset or into a storage container via a second conduit, wherein the system is configured to operate while the pipeline remains in full operation.

18. The system of claim 17, wherein the storage container is a pressurized vessel or a vac-truck.

19. The system of claim 17, wherein the second conduit is coupled at a first end to an outlet of the pump or compressor and at a second end to a second tap assembly provided downstream of the tap assembly.

20. The system of claim 17, further comprising:
a filtration unit positioned between the tap assembly and the pump or compressor, wherein the filtration unit is configured to receive the hydrocarbon liquids from the tap assembly, filter the hydrocarbon liquids to remove paraffin, solids, and other pipeline contaminants that can block or limit efficiency of the pump or compressor, and send the filtered hydrocarbon liquids to the pump or compressor for cross-compression.
